(19) United States
(12) Patent Application Publication
(10) Pub. No.: US 2012/0150588 A1
(43) Pub. Date: Jun. 14, 2012

(54) DYNAMIC PRICING OF PRODUCTS AND OTHER DELIVERABLES

(76) Inventor: Brian Joseph Niedermeyer, Portland, OR (US)

(21) Appl. No.: 13/380,435

(22) PCT Filed: Mar. 27, 2009
(86) PCT No.: PCT/US09/38583

§ 371 Date: Dec. 22, 2011

Related U.S. Application Data
(60) Provisional application No. 61/040,193, filed on Mar. 28, 2008.

(51) Int. Cl. G06Q 30/00; G06Q 10/00

(52) U.S. Cl. 705/7.35; 705/26.1

(57) ABSTRACT

Embodiments herein provide methods, apparatuses, and systems for dynamic pricing of products, services, and other deliverables based on one or more determined factors. Embodiments provide mechanisms to adjust the actual cost of a deliverable based on various deliverable-independent factors, including (a) the location of (i) an individual obtaining the deliverable, (ii) certain equipment, or (iii) the deliverable itself, and (b) the timing of the provision of the deliverable (time of day, season, etc.) or the consummation of the associated transaction.

### CROSS REFERENCE TO RELATED APPLICATIONS

The present application claims priority to U.S. Provisional Patent Application No. 61/040,193, filed Mar. 28, 2008, entitled “DYNAMIC PRICING OF PRODUCTS, SERVICES, AND OTHER DELIVERABLES,” the disclosure of which is hereby incorporated by reference in its entirety.

### TECHNICAL FIELD

Embodiments herein relate to pricing models and methodology, and, more specifically, to dynamic pricing of products and other deliverables based on one or more determined factors.

### BACKGROUND

Traditional retailers, including electronic commerce retailers, establish pricing based on the product sold, including, in some situations, the quantity or amount sold.

Other mechanisms may be utilized to adjust pricing based on the purchasing pattern or habits of the purchaser(s). Some electronic commerce retailers base the pricing of products and services, i.e. music downloads, on the frequency that the product/service is purchased. A song for example may start at $0.25 for each download. As this song is purchased more frequently, the price may be increased upwards, often to a maximum price (i.e., $1.00). This is an automated dynamic feature that is being used today to attempt to optimize sales values.

### BRIEF DESCRIPTION OF THE DRAWINGS

Embodiments will be readily understood by the following detailed description in conjunction with the accompanying drawings. Embodiments are illustrated by way of example and not by way of limitation in the figures of the accompanying drawings.

FIG. 1 illustrates an embodiment of the disclosure in which a computing device independently provides a deliverable for purchase by a first/second individual.

FIGS. 2a-2d illustrate a variety of simple pricing models that may be used to set a price based on demand in accordance with embodiments of the disclosure.

FIG. 3 illustrates a dynamic pricing system in accordance with embodiments of the disclosure.

### DETAILED DESCRIPTION OF DISCLOSED EMBODIMENTS

In the following detailed description, reference is made to the accompanying drawings which form a part hereof, and in which are shown by way of illustration various embodiments. It is to be understood that other embodiments may be utilized and structural or logical changes may be made without departing from the scope. Therefore, the following detailed description is not to be taken in a limiting sense, and the scope of embodiments is defined by the appended claims and their equivalents.

Various operations may be described as multiple discrete operations in turn, in a manner that may be helpful in understanding embodiments herein; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments, are synonymous.

In various embodiments, methods, apparatuses, and systems for dynamic pricing are provided. In exemplary embodiments, a computing device may be endowed with one or more components of the disclosed apparatuses and/or systems and may be employed to perform one or more methods as disclosed herein.

Embodiments herein provide dynamic pricing of deliverables based on factors independent of the qualitative aspects of the deliverable, herein called deliverable-independent factors. Such deliverable-independent factors include (a) the location of (i) an individual obtaining the deliverable, (ii) certain equipment, or (iii) the deliverable itself, and (b) the timing of the provision of the deliverable (time of day, season, etc.) or the consummation of the associated transaction. For example, the price of a product may be in part based on the location from which a product is purchased or to which a product is delivered, as opposed to simply being based on qualities or characteristics of the product itself.

In embodiments, deliverable-independent factors permit the pricing of deliverables to be adjusted by a variety of factors that may allow a provider of such deliverables to increase sales and/or revenues by managing the variable demand for the deliverables.

In an embodiment, deliverables may be provided through an electronic commerce based/enabled transaction mechanism, such as a website accessible via the Internet. Such a mechanism is particularly well suited for dynamic pricing, as the notion of location, for example, is largely irrelevant in electronic commerce. The cost of a product online is the same whether it is purchased by an individual in New York or in Oregon. Of course, there are ancillary costs that may differ based on location, such as taxes or shipping charges; however, such costs are in addition to the cost of the product itself. Embodiments herein address mechanisms to adjust the actual cost of the product (or other deliverable) based on various deliverable-independent factors, such as location.

For the purposes of describing embodiments herein, the term “deliverable” may refer to any product, service or other item that may be purchased and provided for a price/fee.

Certain embodiments provide dynamic pricing based at least in part on location information. In an embodiment, one may use a supply-demand control (for example, the more that is purchased, the higher the price) for dynamic pricing coupled with location information to provide a more accurate pricing model taking into account geographic variations. For example a song may be very popular in New York, N.Y. and may justify a certain price for a song download; however, a person in Portland, Oreg. may have never heard of the artist and/or the band may not be well-known in Portland and thus the local market will only bear a lower price. With location based pricing, the system may use a lower or higher price based, at least in part, on this location information. Thus, price may be a function of demand in a defined location or geographic area, and may differ from a price in another location or geographic area based on the different demand.

FIG. 1 illustrates an embodiment of the disclosure in which a computing device 102 independently provides a deliverable for purchase by a first/second individual, determines a location of the first/second individual, and determines a price of the deliverable for the first/second individual based at least in part on the determined location.

As an example of the embodiment of FIG. 1, a retailer may offer a product for sale on a website. In order to access the website, a user may be asked to first provide information pertaining to the individual's location, or the website may obtain that information automatically, such as through an IP address or a GPS locator. When the user views the particular item on the website, the price displayed to the user may be based on the determined location information. Thus, if a second user accesses the same website, but from a different location, the second user may see a different price.

Thus, in an embodiment, there is provided a method of dynamically pricing a deliverable, comprising providing via a remote commerce interface, a deliverable for purchase by a first individual; determining by a computing device a first price of the deliverable for provision to the first individual based at least in part on location information of the first individual received by the computing device; providing via a remote commerce interface, the deliverable for purchase by a second individual; and determining by the computing device a second price of the deliverable for provision to the second individual based at least in part on location information of the second individual received by the computing device, wherein the first price and the second price are different.

The phrase “remote commerce interface” refers to a variety of commerce/transaction systems, including those used for electronic commerce (such as via the Internet), telephone-based transactions, and other wireless device-based transactions.

Location information may be determined dynamically from a determined physical location of an individual or equipment (a wired or wireless computing device, a cell phone, PDA, etc.), or from a pre-registered location, such as an individual's home or office address.

In an embodiment, location information may be determined from an IP address, GPS, differential or assisted GPS, WAAS, GIS, or any other means of determining a location or area of a person, place, or thing making, or involved in making, a purchase. In embodiments, device triangulation may be used to locate a particular communication device, such as using WiMAX, Wi-Fi, or cellular triangulation, television or radio triangulation, Wi-Fi node location through SSID, Bluetooth, radio frequency identification, etc. In embodiments, a signal strength, angle of arrival, time difference of arrival, and/or observed time difference from or associated with a communication device may be used as a factor to identify the location of a device, such as by determining proximity of a device to a plurality of communication towers or access points.

Location information may be used as a stand alone factor or it may be combined with other tools to set pricing in a current or future market.

The boundaries of one or more locations may be determined as desired, such as determined by city, state, zip code, and so on. The extent of the variances may further be controlled as desired, such as utilizing a supply-demand curve or other model of pricing based on sales/demand.

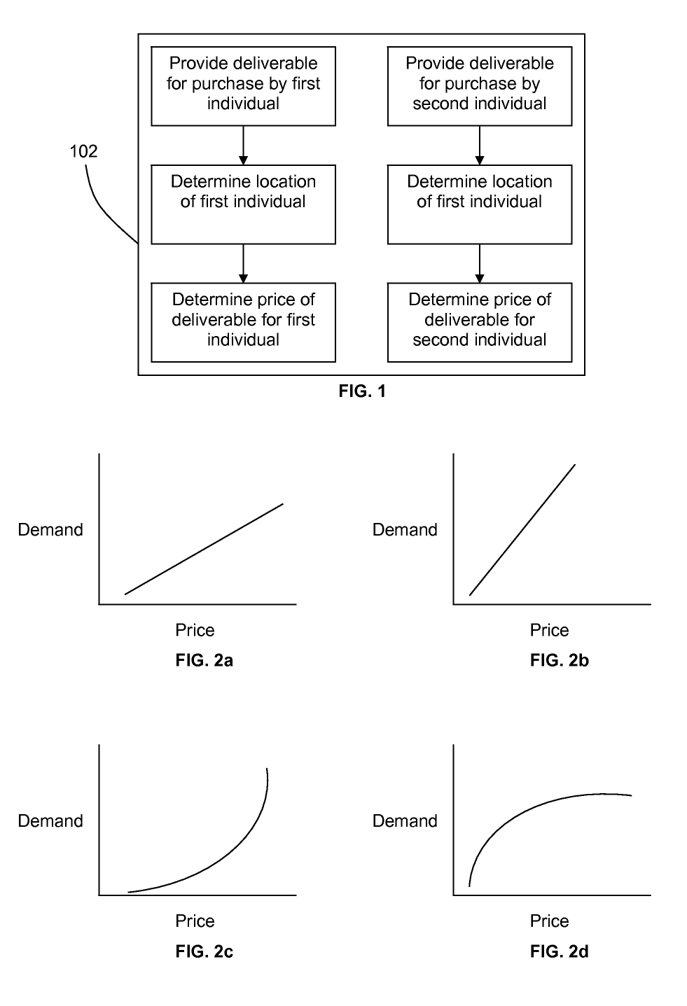

FIGS. 2a-2d illustrate a variety of simple pricing models that may be used to set a price based on demand. The demand factor may be determined in any suitable way (such as gross sales/revenues, etc.) as noted previously. FIGS. 2a and 2b illustrate linear pricing models, while FIGS. 2c and 2d illustrate non-linear pricing models. In embodiments, other models may be utilized. Further, different locations may use the same or different pricing models for the same or different products.

In embodiments, sales/demand information may include the gross sales of a particular item in terms of the number of units sold and/or the revenue generated over a particular time period, the frequency of sales over a particular time period, and/or the acceleration of sales over a particular time period. This information is reflective of the relative demand for a product, which may be correlated to the particular geographic location(s) from which the products were purchased or to which the products were delivered.

In an embodiment, a location based pricing system may be implemented automatically within a sales/delivery system or may be managed manually or may be a combination of both.

In an embodiment, a location based pricing system may function with a wide range of products and services including movies, music, games, ATM services/fees, and other products, services, or deliverables.

In an embodiment, pricing may also incorporate information that includes or reflects specific demographics, i.e. income, age, property tax value or any other such data that may be associated with the purchaser and/or the transaction.

Pricing systems may work with many forms of payments including traditional payment methods as well new ways of purchasing such as the use of a digital wallet or ID, etc.

In an embodiment, pricing may also utilize as a deliverable-independent factor, a location use or industry code. For example a high rise building (having one physical address) may have many different uses or industry codes operating within that address/building. A price for downloading a movie may be higher or lower, for example, if the location was a hotel. As an example, the (IP/location indicator) address originating from a hotel Internet connection may have a different pricing structure on movie rentals/downloads than on the condo floors. Thus, a use factor may be utilized as a location based factor to identify the pricing structure for the particular use.

Another exemplary embodiment applies to the transportation industry. An airplane's or train's Internet connection or known address of an airplane, train etc. may correspond to particular pricing or to a particular model. Since an airplane is mobile, the address may move, and thus the pricing may be based on a permanent location, the location at the time of a transaction, an industry code or designated company code, or another distinguishing characteristic alone or type alone. In an embodiment, a system may recognize that the location of the download is an airplane and may charge a predetermined price, or that price may change depending on the location of the airplane at that particular time.

In an embodiment, more expensive areas with higher property values may have higher purchase costs. The pricing of these products and services with the above criteria may also be used in “on demand” features for television deliverables based on a location of a delivery unit, such as a cable box. In an embodiment, each delivery unit may internally track or remotely track downloads in categories. Based on previous rental data of an individual location or unique identifier, the system may increase or decrease pricing in certain categories of offerings based on historical data. Pay per view sporting events may also be delivered and priced based on demographics and or location history.

In an embodiment, a time or temporal factor may also be coupled with pricing. For example the day of week, season, or time of day may have higher or lower costs associated therewith. This may be important as bandwidth demand increases. In an embodiment, pricing may fluctuate based on time or demand on bandwidth.

In embodiments, it should be understood that all of these methods may in part or in whole be used with all suitable products, services, and other deliverables and that this data may be converted into a score and/or points and or a multiplier, which may be determined or understood using one or more algorithms. One or more of these determined criteria (score, points, etc.) may be used to determine the suitable pricing/model.

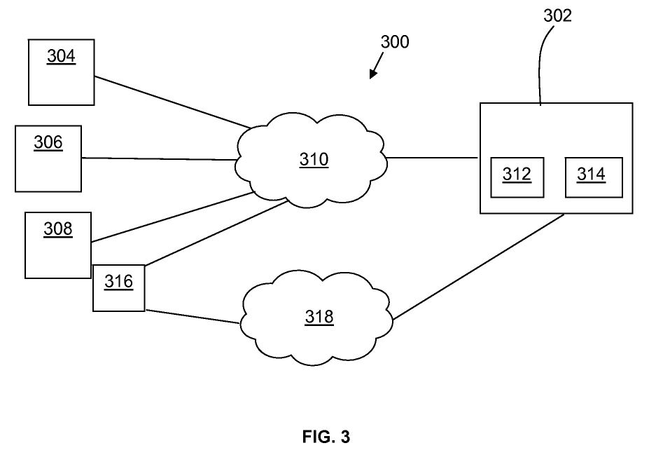

Any one or more of various embodiments previously discussed may be incorporated, in part or in whole, into a system. FIG. 3 illustrates an exemplary embodiment of a dynamic pricing system 300. Pricing system 300 may comprise a computing device 302, such as a pricing server, in communication with client devices 304, 306, 308, which may be wired or wireless. Computing device 302 may be communicatively coupled with client devices 304, 306, 308 via a network 310, such as the Internet, a local network, etc.

Computing device 302 may include one or more processors 312 for obtaining/receiving demand data, obtaining/receiving location information, determining pricing based on demand, etc. One or more of the processors 312 may be adapted to perform methods in accordance with various methods as disclosed herein. Processor(s) 312 may receive location information from one or more of client devices 304, 306, 308. In addition, or alternatively, processor(s) 312 may receive location information from a separate device 316 (such as a cell phone, PDA, GPS locator) that is associated with an individual and/or with, for example, client device 308. Location information from device 316 may be provided over network 310 or may be provided over a second network 318, which may be the same or different type of network as network 310.

Computing device 302 may also include one or more computer readable storage media 314, such as a hard disk drive, diskette, compact disk, etc., in which may be stored various data, pricing models, etc.

Any one or more of various embodiments as previously discussed may be incorporated, in part or in whole, into an article of manufacture. In various embodiments, an article of manufacture may comprise a computer readable storage medium (hard disk, floppy disk, CD, etc.) and a plurality of programming instructions stored in the computer readable storage medium. In various ones of these embodiments, programming instructions may be adapted to program an apparatus to enable the apparatus to perform one or more of the previously-discussed methods.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

What is claimed is:

1. A method of dynamically pricing a deliverable, comprising:
providing via a remote commerce interface, a deliverable for purchase by a first individual;
determining by a computing device a first price of the deliverable for provision to the first individual based at least in part on location information of the first individual received by the computing device;
providing via a remote commerce interface, the deliverable for purchase by a second individual; and
determining by the computing device a second price of the deliverable for provision to the second individual based at least in part on location information of the second individual received by the computing device,
wherein the first price and the second price are different.

2. The method of claim 1, wherein determining a first price and determining a second price comprises determining demand for the deliverable in the location of the first individual and determining demand for the deliverable in the location of the second individual.

3. The method of claim 2, wherein determining demand for the deliverable comprises determining the demand in real time while the deliverable is being accessed, viewed, or purchased via the remote commerce interface by the first or second individual.

4. The method of claim 2, wherein determining demand for the deliverable comprises determining gross sales of the deliverable based on number of units sold and/or revenue generated in a defined time period.

5. The method of claim 2, wherein determining demand for the deliverable comprises determining frequency of sales of the deliverable over a defined time period.

6. The method of claim 2, wherein determining demand for the deliverable comprises determining acceleration of sales of the deliverable over a defined time period.

7. The method of claim 1, wherein providing the deliverable for purchase via a remote commerce interface comprises providing the deliverable for purchase via a website.

8. The method of claim 1, further comprising determining the location information of the first and/or second individuals by determining a physical location of the first and/or second individuals.

9. The method of claim 8, wherein determining a physical location of the first and/or second individuals comprises determining a location of a GPS locator associated with the first and/or second individuals.

10. The method of claim 8, wherein determining a physical location of the first and/or second individuals comprises determining a location of an IP address of a computing device used by the first and/or second individuals to access the remote commerce interface.

11. The method of claim 1, further comprising determining the location information of the first and/or second individuals by determining a particular use or industry code at a physical location of the first and/or second individuals.

12. The method of claim 1, wherein determining the first price of the deliverable and the second price of the deliverable further comprises independently determining at least one of the first price and the second price based on a temporal factor.

13. The method of claim 12, wherein the temporal factor comprises a time of day, one or more days, a week, a month, or a season.

14. A method of dynamically pricing a deliverable, comprising:
providing via a remote commerce interface, a deliverable for purchase by a plurality of individuals; and
determining by a computing device a price of the deliverable for provision to each of the plurality of individuals based at least in part on a determined location of at least one of (a) the individual purchasing the deliverable, (b) equipment associated with the individual purchasing the deliverable, and (c) the deliverable itself.

15. A tangible computer-readable medium having stored thereon, computer-executable instructions that, if executed by a computing device, cause the computing device to perform a method comprising:
providing via a remote commerce interface, a deliverable for purchase by a first individual;
determining by a computing device a first price of the deliverable for provision to the first individual based at least in part on location information of the first individual received by the computing device;
providing via a remote commerce interface, the deliverable for purchase by a second individual; and
determining by the computing device a second price of the deliverable for provision to the second individual based at least in part on location information of the second individual received by the computing device,
wherein the first price and the second price are different.
